(19) United States
(12) Patent Application Publication
(10) Pub. No.: US 2009/0290871 A1
(43) Pub. Date: Nov. 26, 2009

(54) SIGNAL-LIGHT IDENTIFYING APPARATUS, WDM TRANSCEIVER, AND METHOD OF IDENTIFYING SIGNAL LIGHT

(75) Inventor: Toshiki Honda, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/360,571

(22) Filed: Jan. 27, 2009

(30) Foreign Application Priority Data
May 23, 2008 (JP) 2008-135911

(51) Int. Cl. H04J 14/00; H04J 14/02

(52) U.S. Cl. 398/45; 398/79

(57) ABSTRACT

Spectral components of input signal light is partially removed by allowing the input signal light regulated to predetermined power to pass through an optical filter, and the rate of the input signal light is identified in response to the power of the signal light passing through the optical filter.

### CROSS-REFERENCE TO RELATED APPLICATION

This application is based upon and claims the benefit of priority of the prior Japanese Application No. 2008-135911 filed on May 23, 2008 in Japan, the entire contents of which are hereby incorporated by reference.

### FIELD

The embodiment(s) discussed herein is (are) related to a signal-light identifying apparatus, a wavelength division multiplexing (WDM) transceiver and a method of identifying signal light.

### BACKGROUND

There is a next-generation 40-Gbps optical transceiver system. It is better for such an optical transceiver system to include a transmission distance and a frequency utilization rate similar to those of 10-Gbps optical transceiver system.

Some methods to achieve these include return to zero-differential phase shift keying (RZ-DPSK) modulation and carrier suppressed RZ-DPSK (CSRZ-DPSK) modulation.

Such modulation methods have high resistance to the optical signal noise ratio (OSNR) and nonlinearity compared with, for example, non return to zero (NRZ) modulation, which can be used in a 10-Gbps or lower optical transceiver system.

Intensive research and development for RZ-differential quadrature phase shift keying (RZ-DQPSK) modulation and carrier suppressed return to zero-quadrature phase shift keying (CSRZ-DQPSK) modulation that uses narrower spectra (higher frequency) compared to the modulation methods mentioned above have been carried out.

As an optical receiver demodulating signal light modulated by the DPSK modulation or the DQPSK modulation, one that includes a delay interferometer has been studied.

Moreover, in view of efficient use of existing system resources, one market need is combined use of DPSK modulated or DQPSK modulated 40-Gbps signal light and NRZ modulated 10-Gbps signal light in a WDM transceiver system.

[Patent Document 1] Japanese Laid-open Patent Publication No. 2006-5937

Such a WDM transceiver system, for example, involves wavelength assignment and routing control corresponding to the rate of signal light. However, in the related art, the rate of signal light can be identified only through light reception processing, such as conversion of received signal light into an electric signal.

### SUMMARY

(1) Accordingly to an aspect of the embodiment, an apparatus includes a signal-light identifying apparatus including an optical filter removing a part of spectral components of input signal light regulated to have predetermined power; and an identifying unit identifying a rate of the input signal light in response to power of signal light passing through the optical filter.

(2) Accordingly to an aspect of the embodiment, an apparatus includes a WDM transceiver transmitting WDM signal light, including a wavelength multiplexing unit wavelength-multiplexing a plurality of signal light components having different wavelengths; and the signal-light identifying apparatus identifying rates of input signal light, the input signal light being each of the plurality of signal light components or being the WDM signal light wavelength-multiplexed by the wavelength multiplexing unit.

(3) Accordingly to an aspect of the embodiment, a method includes a method of identifying signal light, including removing a part of spectral components of an input signal light having regulated predetermined by passing the input signal light through an optical filter; and identifying a rate of the input signal light in response to the power of signal light passing through the optical filter.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF THE DRAWINGS

FIG. 1 illustrates an exemplary WDM transceiver system according to an embodiment.

FIG. 2 is a block diagram of an exemplary WDM transceiver system according to a first implementation.

FIG. 3 illustrates a waveform of 40-Gbps signal light in a frequency range.

FIG. 4 illustrates a waveform of 10-Gbps signal light in a frequency range.

FIG. 5 is a schematic view illustrating frequency components of 10-Gbps signal light and 40-Gbps signal light.

FIG. 6 is a flow chart illustrating a typical operation of the WDM transceiver system according the first implementation.

FIG. 7 is a block diagram of an exemplary WDM transceiver system according to a second implementation.

FIG. 8 is a flow chart of a typical operation of the WDM transceiver system according the second implementation.

FIG. 9 is a block diagram of an exemplary WDM transceiver system according to a third implementation.

FIG. 10 is a block diagram of an exemplary WDM transceiver system according to a fourth implementation.

### DESCRIPTION OF EMBODIMENTS

### [1] Embodiment

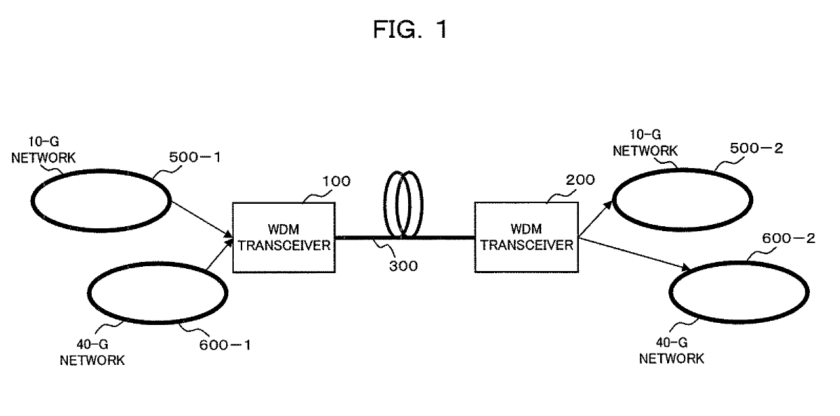

FIG. 1 is a block diagram of an exemplary WDM transceiver system according to an implementation. The WDM transceiver system illustrated in FIG. 1 includes WDM transceivers 100 and 200 that are connected by an optical transmission line 300, such as optical fiber, and communicate with each other.

For example, the WDM transceiver 100 can receive signal light via a 10-Gbps optical network (10-G network) 500-1 or a 40-Gbps optical network (40-G network) 600-1 and transmit the signal light to the WDM transceiver 200.

The WDM transceiver 200 can transmit (route) the WDM signal light received via the optical transmission line 300 to other networks, such as a 10-G network 500-2 and a 40-G network 600-2. FIG. 1 illustrates a configuration of unidirectional optical communication from the left to the right in the drawing. This transceiver can also carry out bidirectional communication.

For example, on transmission of 40-Gbps signal light by the WDM transceiver 100 at the sender, a receiving error may occur on the receiver due to spectrum overlapping and cross phase modulation (XPM) if an NRZ-modulated 10-Gbps signal light exists at an adjacent wavelength.

Therefore, a user (network manager) of a WDM transceiver system carefully selects which signal light having what rate is to be assigned to which wavelength of the WDM signal light.

Unfortunately, as described above, the rate of the signal light can be identified only after reception processing (electric signal processing). Therefore, even if a user misconnects the optical fiber and inputs signal light having an unexpected rate to the WDM transceiver 100, to the user cannot readily recognize the misconnection unless a line is affected. As a result, XPM occurs for a long period of time. This may impair the transmission efficiency of the WDM transceiver system.

In the WDM transceiver 200, the routing (routing control) to different routes in response to the rate of signal light to the 10-G network 500-2 and the 40-G network 600-2 requires fine control using a computer because the rate cannot be identified without electric signal processing. Consequently, complicated control is required for the WDM transceiver 200.

In this embodiment, the rate of the signal light is identified by a difference in the spectral width, which increases in the corresponding frequency range as the rate of the signal increases. For example, the spectral widths of 10-Gbps signal light and 40-Gbps signal light differ by approximately two times. Therefore, for example, monitoring the power of the partially removed spectral components of input signal light controlled to predetermined power can identify the rate of the input signal light. Such a process can identify the rate of input signal light without conversion of the input signal light into an electric signal (i.e., without electric signal processing).

Consequently, an input of signal light having an unexpected rate due to misconnection to the WDM transceiver 100 can be easily detected, and thus, the generation of unexpected XPM can be prevented.

Furthermore, the WDM transceiver 200 can identify the rate of the signal light directly, and can perform routing control corresponding to the identified result. Accordingly, management and control of the WDM transceiver system can be simplified.

### [2] Implementations of WDM Transceiver System

The WDM transceiver system described above will be described in detail below.

### (2.1) First Implementation

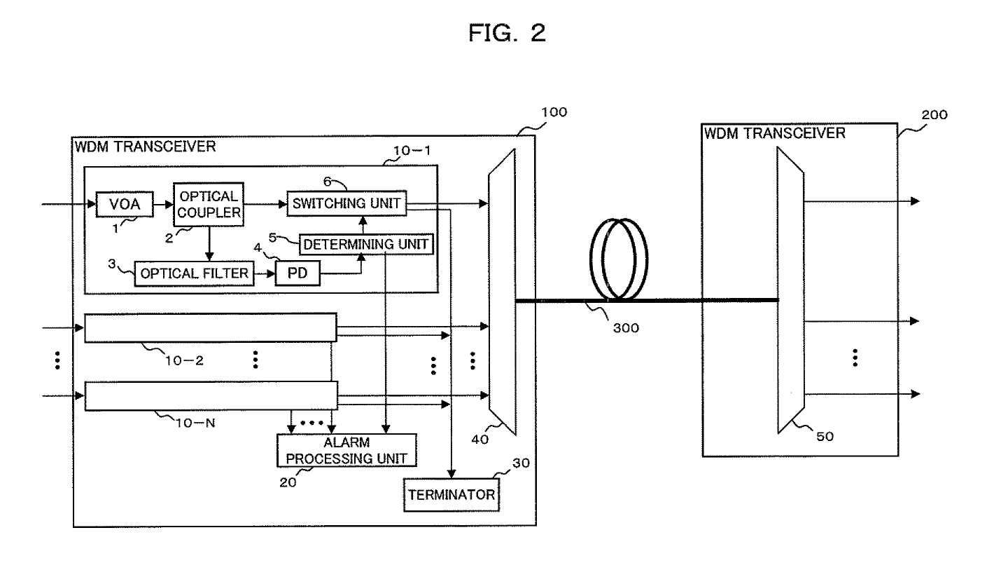

FIG. 2 is a block diagram of a WDM transceiver system according to a first implementation. The WDM transceiver system illustrated in FIG. 2 includes a WDM transceiver 100 functioning as an optical transmitter (hereinafter, referred to as optical transmitter 100), a WDM transceiver 200 functioning as an optical receiver (hereinafter referred to as optical receiver 200), and an optical transmission line 300 connecting the optical transmitter 100 and the optical receiver 200. The optical transmitter 100 wavelength-multiplexes a plurality of signal light components having different wavelengths, received from a transmitter network (not illustrated), and sends the WDM signal light to the optical transmission line 300. The optical receiver 200 wavelength-separates the WDM signal light received from the optical transmitter 100 and send the wavelength-separated WDM signal light to a receiver network (not illustrated).

The optical receiver 200 includes a WDM coupler 50. The WDM coupler (wavelength separating unit) 50 separates the WDM signal light from the optical transmission line 300 by every wavelength.

The optical transmitter 100 includes monitoring units 10-1 to 10-N (N represents a positive integer), an alarm processing unit 20, a terminator 30, and a WDM coupler 40. Signal light having a different wavelength is input to each of the monitoring units 10-1 to 10-N. The signal light passing through each of the monitoring units 10-1 to 10-N is wavelength-multiplexed at the WDM coupler 40 and is sent to the optical transmission line 300. Hereinafter, the monitoring units 10-1 to 10-N will be referred to as monitoring units 10 unless they can be differentiated.

The monitoring units 10 of the optical transmitter 100 directly identifies the rate of the input signal light for each wavelength, and, on the basis of the identified result, carries out alarm processing and optical termination processing by cooperative operation of the alarm processing unit 20 and the terminator 30.

Accordingly, each of the monitoring units 10 of this embodiment includes a variable optical attenuator (VOA) 1, an optical coupler 2, an optical filter 3, a photo diode (PD) 4, a determining unit 5, and a switching unit 6.

The VOA 1 regulates signal light input to the monitoring unit 10 to a predetermined level of power.

The optical coupler 2 demultiplexes the signal light from the VOA 1 into signal (light) components and test (light) components. The signal components are sent to the switching unit 6, whereas the test components are sent to the optical filter 3. The demultiplexing ratio of the signal components to the test components may be approximately 10 to 1.

The optical filter 3 partially removes spectral components of the test components input from the optical coupler 2. The partially removed spectral components may be, for example, spectral components in a predetermined range not including the central frequency of the test components (i.e., the central frequency of the input signal light) or spectral components in a predetermined range including the central frequency of the test components.

The PD 4 detects the power of a signal light component passing through the optical filter 3, and the detected result is notified to the determining unit 5.

The determining unit 5 identifies the rate of the input signal light on the basis of the power of the signal light component detected at the PD 4. In this embodiment, the determining unit 5 compares the power detected at the PD 4 and a threshold and identifies the rate of the signal light on the basis of the result of the comparison.

The identification operation of the VOA 1, the optical coupler 2, the optical filter 3, the PD 4, and the determining unit 5 will be described with reference to the drawings.

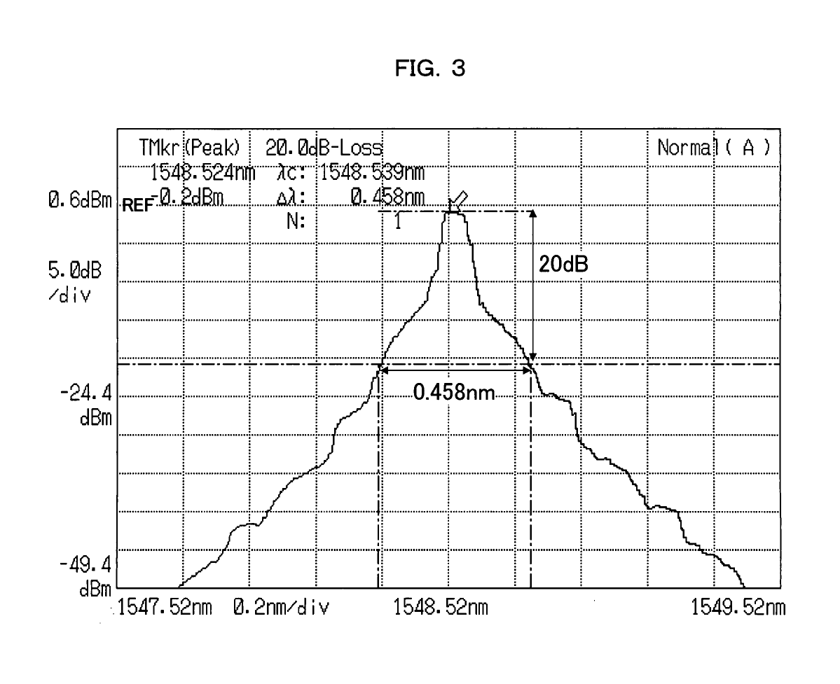

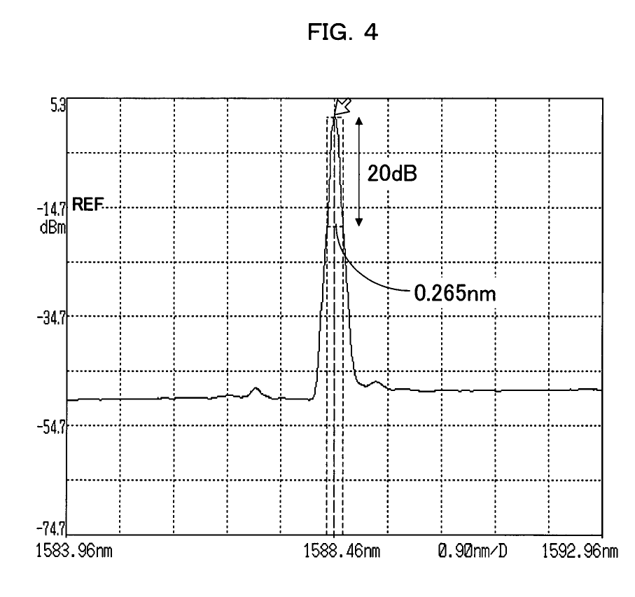

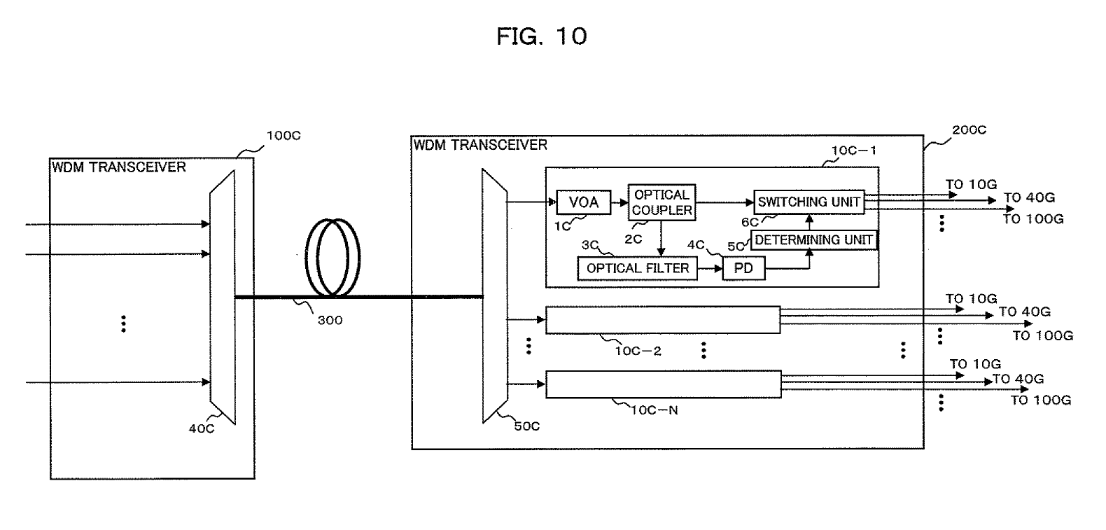

In general, the higher the rate of signal light (the higher the bit rate), the greater the spectral width. As specific examples, 40-Gbps signal light illustrated in FIG. 3 and 10-Gbps signal light illustrated in FIG. 4 will be described.

DQPSK modulation is performed on the 40-Gbps signal light, while NRZ modulation is performed on the 10-Gbps signal light. Different modulation processes also cause a difference in spectral width. However, since the difference in spectral width caused by the different modulation processes is small compared with the difference in spectral width caused by the rate difference, the difference in spectral width caused by the different modulation processes will not be considered hereinafter.

In the signal light waveforms illustrated in FIGS. 3 and 4, the spectral width having a value which is 20 dB lower than the peak value of the signal light (indicated by the outline arrows in FIGS. 3 and 4) will be discussed. The 40-Gbps signal light has a spectral width of approximately 0.458 nm, whereas the 10-Gbps signal light has a spectral width of approximately 0.265 nm.

In other words, the spectral width of the 40-Gbps signal light is approximately twice the spectral width of the 10-Gbps signal light. Similarly, the gain density is different by approximately two times.

In this implementation, the VOA 1 controls the 10-Gbps or 40-Gbps signal light input to the optical transmitter 100, and the optical coupler 2 separates the signal light from the VOA 1 into signal components and test components and sends the test components to the optical filter 3.

Then, among the test components from the optical coupler 2, the optical filter 3 transmits the signal components in a predetermined spectral band containing the central frequency of the test components.

At this time, selection of an appropriate pass frequency (or cutoff frequency) of the optical filter 3 leads to a power difference which is detected at the PD 4 in response to the rate of the signal components passing through the optical filter 3, due to the difference in spectral width.

The determining unit 5 directly identifies the rate of the input signal light on the basis of this power difference without any operation.

In this implementation, for example, the pass frequency of the optical filter 3 is set such that the optical filter 3 transmits 10-Gbps signal light. The optical filter 3 may be a wavelength-tunable optical filter. In such a case, the pass band (pass window) of the optical filter 3 may be set such that the power difference is maximized. This way increases the success rate of the identification.

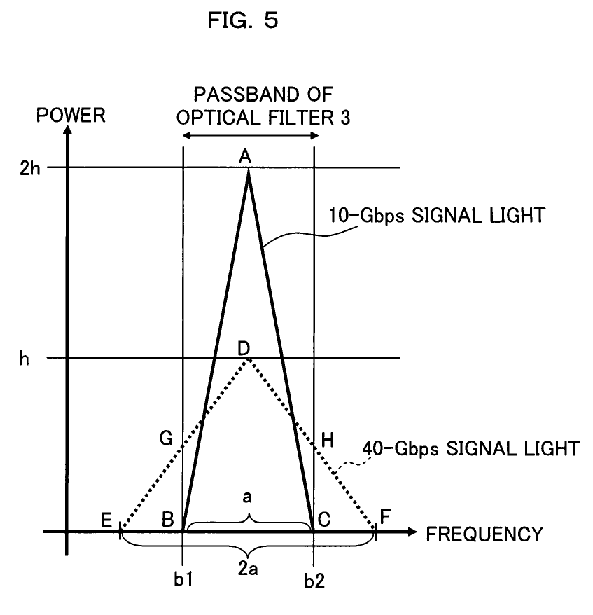

FIG. 5 is a schematic view of 10-Gbps signal light and 40-Gbps signal light in a frequency range.

In FIG. 5, triangle ABC (base a and height 2h, where a and h are positive integers) and triangle DEF (base 2a and height h) schematically illustrates the signal light waveforms of the 10-Gbps signal light and the 40-Gbps signal light, respectively. The spectral band defined by the frequency b1 and the frequency b2 indicates the pass band of the optical filter 3. Reference characters G and H represent the intersections of the triangle DEF and the pass window of the optical filter 3.

Since the VOA 1 controls the 10-Gbps signal light and the 40-Gbps signal light to predetermined powers, the area of the triangle ABC (=power of the 10-Gbps signal light) equals to the area of the triangle DEF (=power of the 40-Gbps signal light).

However, in the signal light components passing through the optical filter 3 (the area between frequency b1 and frequency b2), the power of the 10-Gbps signal light equals the area of the triangle ABC (==a×2h×½=ah).

Alternatively, the power of the 40-Gbps signal light equals the area of pentagon DGBCH (=triangle DEF−triangle GEB−triangle CFH=ah−a/2×h/2×½−a/2×h/2×½=3ah/4)

Therefore, when the rate of the signal light (test components) passing through the optical filter 3 is 10-Gbps, the PD 4 detects a power represented by, for example, “ah”. On the other hand, when the rate of the signal light (test components) passing through the optical filter 3 is 40-Gbps, the PD 4 detects a power represented by, for example, “3ah/4”.

As illustrated in FIG. 5, a power difference of approximately 25% due to the difference in the input signal light rate is detected at the PD 4. Consequently, the determining unit 5 can directly identify the rate of the input signal light by detecting the power difference. FIG. 5 is schematic view for simple description. Actually, the power tends to concentrate to the central frequency. Therefore, an optical filter having a narrower bandwidth may be used.

For example, it is desirable to set the pass band of the optical filter 3 to 0.1 nm or smaller in order to differentiate 10-Gbps signal light and 40-Gbps signal light.

Then, the determining unit 5 compares the power detected at the PD 4 with a predetermined threshold (voltage). When the detected result is smaller than the threshold, the rate of the signal light input to the VOA 1 is identified to be 40-Gbps signal light.

Alternatively, when the detected result is equal to or greater than the threshold, the rate of the signal light input to the VOA 1 is identified to be 10-Gbps signal light. At this time, the predetermined threshold may be set between the 10-Gbps signal light power and the 40-Gbps signal light power detected by the PD 4.

For example, when the VOA 1 controls the power of the input signal light to 10 mW, the rate can be identified by setting the predetermined threshold to 7.5 mW.

This implementation involves a case in which the optical filter 3 transmits a predetermined spectral band including the central frequency of input signal light. Instead, the optical filter 3 may block (remove) a spectral band including the central frequency, and the rate may be identified on the basis of the power corresponding to remaining pass band.

In such a case, the power of the 10-Gbps signal light passing the optical filter 3 is 0 mW, whereas the power of the 40-Gbps signal light passing the optical filter 3 is 2.5 mW.

Therefore, the determining unit 5 can identify the rate of the input signal light by setting the predetermined threshold to 2.5 mW.

In other words, the PD 4 and the determining unit 5 function as an identifying unit identifying the rate of signal light on the basis of the power of the signal light passing through the optical filter 3.

Moreover, the determining unit 5 controls the operation of the switching unit 6 and the alarm processing unit 20 on the basis of the identified result.

Under the control by the determining unit 5, the switching unit 6 outputs the signal components from the optical coupler 2 to a route (path) in response to the identified result.

For example, when the rate of input signal light is identified to be an unexpected rate, the input signal light is output to a route to the terminator 30. When the rate is any other rate, the input signal light is output to a route to the WDM coupler 40.

The terminator (optical terminating unit) 30 optically terminates the signal light output from the switching unit 6 when the identified rate of the input signal light in the determining unit 5 is an unexpected rate. Such optical termination may be carried out by radiating the input signal light to the atmosphere or by blocking the reflection of the input signal light.

The alarm processing unit 20 carries out alarm processing under the control of the determining unit 5. The alarm processing in this implementation may be carried out to warn the user of the WDM transceiver system about an abnormality, by, for example, illuminating an alarm lamp of the monitoring units 10 receiving the signal light or notifying a network management station (NMS).

The alarm processing may be automatically triggered when the determining unit 5 switches the output of the switching unit 6 to the terminator 30.

In this way, the user of the WDM transceiver system (for example, a network manager) may be quickly notified that the wavelength assignment of the optical transmitter 100 is unsuitable. This can prevent unexpected XPM from generating and the transmission efficiency of the WDM transceiver system from decreasing.

The WDM coupler (wavelength multiplexing unit) 40 wavelength-multiplexes the signal light having different wavelength passing through the monitoring units 10-1 to 10-N and outputs the signal light to the optical transmission line 300.

In other words, the monitoring units 10, the alarm processing unit 20, and the terminator 30 operate as a signal-light identifying apparatus.

As described above, the optical transmitter 100 in this implementation partially removes spectral components of the input signal light controlled to a predetermined power and identifies the rate of the signal light on the basis of the power of the remaining signal light.

Consequently, the optical transmitter 100 handling signal light having different rates, such as 10 Gbps and 40 Gbps, can directly identify the rate of the signal light at high speed. Therefore, unexpected input signal light can be blocked (optically terminated) at high speed.

This can prevent unexpected XPM from generating and the transmission efficiency of the WDM transceiver system from decreasing.

As described above, rate identification of the signal light input to the optical transmitter 100 is carried out. In such a case, since the wavelength of the signal light input to the optical transmitter 100 is predetermined, the optical filter 3 may be a fixed-wavelength filter.

If the rate or the modulation method causes a significant difference in the spreading of the spectral width of the signal light, three or more different rates of signal light can be identified.

As described above, the monitoring units 10 is disposed at the input section of the WDM coupler 40 of the optical transmitter 100 for the following reason. Since input signal light is not multiplexed at the input section of the WDM coupler 40, blocking unexpected signal light in this section can efficiently suppress the effect to other signal light. Since wavelength of the input signal light is restricted, a fixed-wavelength filter can be used as the optical filter 3, resulting in a reduction in cost of the apparatus. The position of the monitoring units 10 is not limited to the position described above, and may be disposed anywhere on the WDM transmission line.

Moreover, since the determining unit 5 does not have to be operated when there is no input to the PD 4, operation of the determining unit 5 may be triggered when the loss of light (LOL) state of the PD 4 is canceled.

As described above, the alarm processing unit 20 and the terminator 30 are shared by the monitoring units 10. Alternatively, individual alarm processing units 20 and terminators 30 may be provided for the monitoring units 10.

### (2.2) Operation of Optical Transmitter 100

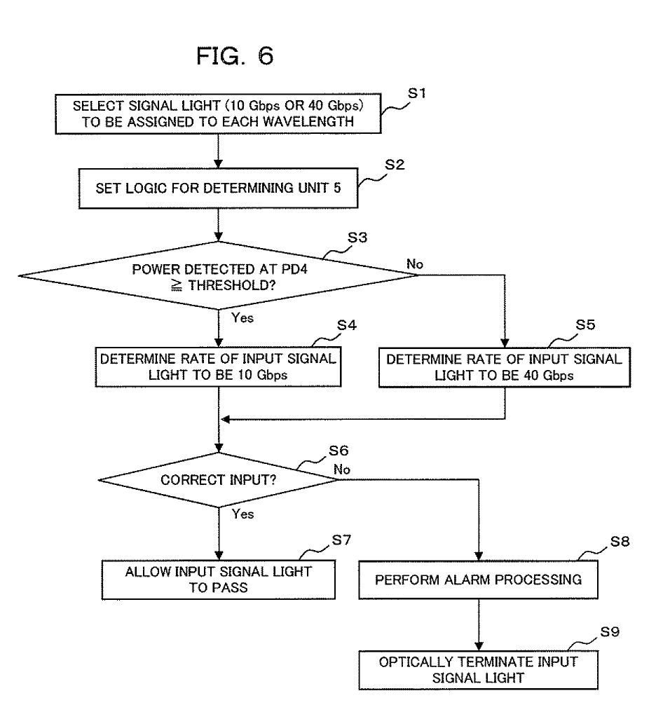

Next, operation of the optical transmitter 100 (signal light identification method) will be described with reference to FIG. 6.

First, a user selects the type of signal light to be assigned to each wavelength (10 Gbps or 40 Gbps) for wavelength-multiplexing (Step S1). The user selects the type (mainly rate) of input signal light to be assigned to each wavelength such that the wavelengths of the signal light, e.g., 10 Gbps and 40 Gbps, are not adjacent to each other.

The determining unit 5 sets a determination (identification) logic of Step S6, described below, on the basis of the selected type of the input signal light (Step S2).

For example, 10-Gbps signal light is preliminarily assigned to a specific wavelength in Step S1. In such a case, the determining unit 5 determines that the signal light is correctly input if the rate of the input signal light having the specific wavelength is 10 Gbps. On the other hand, the determining unit 5 determines that the signal light is incorrectly input, if the input signal light is 40 Gbps.

If 40-Gbps signal light is assigned to a specific wavelength in Step S1, the determining unit S sets a determination logic opposite to that described above.

Next, the monitoring units 10 controls the input signal light to a predetermined power by the VOA 1 and separates the input signal light into signal components and test components by the optical coupler 2. Then, the test components are input to the optical filter 3 where specific spectral components of the test components are blocked (or transmitted).

The power of the test components passing through the optical filter 3 is detected by the PD 4, and the determining unit 5 compares the detected power with a predetermined threshold (Step S3).

When the determining unit 5 identifies (determines) that the power detected by the PD 4 is equal to or greater than the predetermined threshold (YES route in Step S3), the rate of the input signal light is determined to be 10 Gbps (Step S4). When the determining unit 5 identifies (determines) that the power detected by the PD 4 is smaller than the predetermined threshold (NO route in Step S3), the rate of the input signal light is determined to be 40 Gbps (Step S5).

Then, the determining unit 5 determines whether the signal light is correctly input on the basis of the determination logic set in Step S2 (Step S6).

When the determining unit 5 determines that the signal light is correctly input (YES route in Step S6), the output of the switching unit 6 is switched to a route to the WDM coupler 40 so that the input signal light is transmitted (Step S7).

When the determining unit 5 determines that the signal light is incorrectly input (NO route in Step $6), the alarm processing unit 20 carries out alarm processing (Step S8) and the output of the switching unit 6 is switched to a route to the terminator 30. The signal light sent to the terminator 30 is terminated (blocked) by the terminator 30 (Step S9). Steps S8 and S9 may be carried out in a reversed order or may be carried out simultaneously.

In this way, spectral components of the input signal light controlled to a predetermined power at the optical transmitter 100 are partially removed, and the rate of the input signal light is identified on the basis of the power of the passing signal light components.

Since the rates of signal light having different rates, such as 10 Gbps and 40 Gbps, can be directly identified at high speed, unexpected signal light can be blocked at high speed.

This can prevent unexpected XPM from generating and the transmission efficiency of the WDM transceiver system from decreasing.

### (2.3) Second Implementation

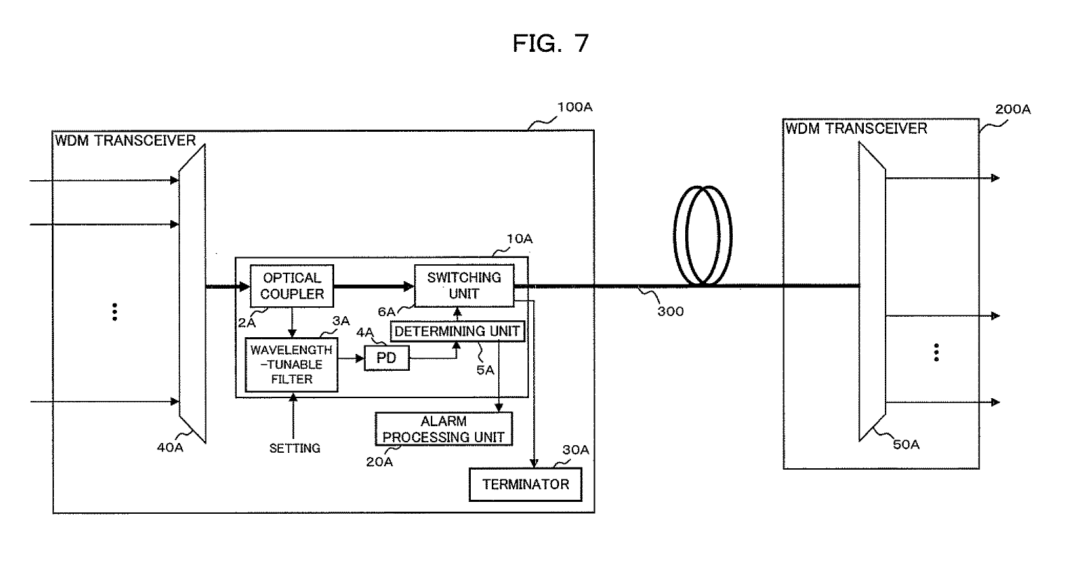

An optical transmitter 100A illustrated in FIG. 7 may be used instead of the optical transmitter 100 illustrated in FIG. 2.

FIG. 7 is a block diagram of a WDM transceiver system according a second implementation. The WDM transceiver system illustrated in FIG. 7 includes a WDM transceiver 100A functioning as an optical transmitter (hereinafter, referred to as optical transmitter 100A), a WDM transceiver 200A functioning as an optical receiver (hereinafter referred to as optical receiver 200A), and an optical transmission line 300 connecting the optical transmitter 100A and the optical receiver 200A.

The optical transmitter 100A has the same configuration and function as those of the optical transmitter 100.

In the implementation described above, the rate is identified on input signal light that is not wavelength-multiplexed at the WDM coupler 40. In this implementation, the rate is identified on one of the signal light components after wavelength-multiplexing at a WDM coupler 40A.

Therefore, the optical transmitter 100A includes the WDM coupler 40A, a monitoring unit 10A disposed downstream of the WDM coupler 40A, an alarm processing unit 20A, and a terminator 30A. The alarm processing unit 20A and the terminator 30A have the same functions as those of the alarm processing unit 20 and the terminator 30, respectively.

The WDM coupler 40A of the optical transmitter 100A wavelength-multiplexes a plurality of signal light having different wavelengths and outputs a WDM signal light.

The monitoring unit 10A directly identifies the rate of signal components having different wavelengths (hereinafter, referred to as wavelength components) included in the WDM signal light and carries out alarm processing and optical termination on the basis of the identified result.

The monitoring unit 10A includes an optical coupler 2A, a wavelength-tunable optical filter 3A, a PD 4A, a determining unit 5A, and a switching unit 6A.

The optical coupler 2A demultiplexes the WDM signal light from the WDM coupler 40A into signal (light) components and test (light) components. The signal components are sent to the switching unit 6A, whereas the test components are sent to the wavelength-tunable optical filter 3A. The demultiplexing ratio of the signal components to the test components may be approximately 10 to 1.

The wavelength-tunable optical filter 3A partially removes spectral components of signal light having a specific wavelength included in the test components (WDM signal light) from the optical coupler 2A on the basis of wavelength setting control by a control unit not illustrated in the drawings. The spectral components partially removed by the optical filter 3 are, for example, spectral components in a predetermined range not including the central frequency of the wavelength components.

The PD 4A detects the power of the signal light components passing through the wavelength-tunable optical filter 3A and notifies the detected result to the determining unit 5A.

The determining unit 5A identifies the rate of the signal light on the basis of the power of the signal light detected at the PD 4A. To identify the rate, for example, the power detected at the PD 4A is compared with a predetermined threshold. The rate is identified on the basis of the result of the comparison. The same rate identification procedure as that described above is employed.

The determining unit 5A controls the operation of the switching unit 6A and the alarm processing unit 20A on the basis of the identified result.

Under the control by the determining unit 5A, the switching unit 6A outputs the signal components (WDM signal) from the optical coupler 2A to a route (path) in response to the identified result.

For example, when the rate of at least one wavelength component of the WDM signal light is identified to be an unexpected rate, the WDM signal light is output to a route to the terminator 30A. When the rate is any other rate, the WDM signal light is output to a route to the optical transmission line 300.

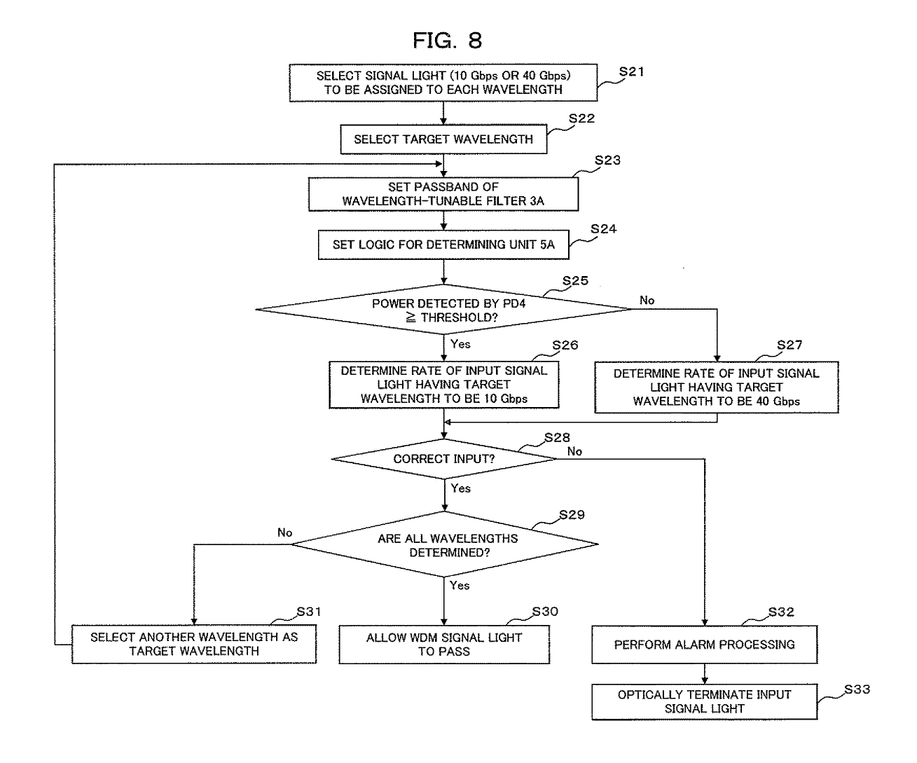

An exemplary operation (signal light identification procedure) of the optical transmitter 100A according to this implementation will be described with reference to FIG. 8.

First, a user selects the type of signal light to be assigned to each wavelength (10 Gbps or 40 Gbps) for wavelength-multiplexing (Step S21). The user selects the type (mainly rate) of input signal light to be assigned to each wavelength such that the wavelengths of the signal light, e.g., 10 Gbps and 40 Gbps, are not adjacent to each other.

The monitoring unit 10A selects the first wavelength to be identified from the wavelengths included in the WDM signal light (Step S22).

The control unit (not illustrated) sets the passband of the wavelength-tunable optical filter 3A such that predetermined spectral components including the central frequency of the selected wavelength components are transmitted (Step S23).

The determining unit 5A sets a determination (identification) logic of Step S28, described below, on the basis of the type of the input signal light selected in Step S21 (Step S24).

The monitoring unit 10A demultiplexes the WDM signal light from the WDM coupler 40A into signal components and test components using the optical coupler 2A. Then, the test components are input to the wavelength-tunable optical filter 3A where spectral components of the test components in the frequency band set in Step S23 are transmitted.

The power of the test components passing through the wavelength-tunable optical filter 3A is detected by the PD 4A, and the determining unit SA compares the detected power with the predetermined threshold (Step S25).

When the determining unit 5A determines that the power detected by the PD 4A is equal to or greater than the predetermined threshold (YES route in Step S25), the rate of the wavelength component of the signal light is determined (identified) to be 10 Gbps (Step S26). When the determining unit 5A determines that the power detected by the PD 4A is smaller than the predetermined threshold (NO route in Step S25), the rate of the wavelength component of the signal light is determined (identified) to be 40 Gbps (Step S27).

Then, the determining unit 5A determines whether the wavelength component is correctly input on the basis of the determination logic set in Step S24 (Step S28).

When the determining unit 5A determines that the wavelength component is correctly input (YES route in Step S28), the monitoring unit 10A determines whether or not the determination process in Step S28 is carried out for all wavelengths in the input WDM signal (Step S29).

When the monitoring unit 10A determines that all wavelengths included in the WDM signal light are input correctly (YES route in Step S29), the output of the switching unit 6A is switched to transmit the WDM signal light (Step S30).

When the determination process in Step S28 is not carried out for all wavelengths in the WDM signal light (NO route in Step S29), another wavelength is selected for rate identification and the processes from Steps S23 to S29 are repeated.

During this loop processing, when it is determined that at least one wavelength component included in the WDM signal light is incorrectly input (NO route in Step S28), the monitoring unit 10A carries out alarm processing using the alarm processing unit 20A (Step S32) and switches the output of the switching unit 6A to a route to the terminator 30A. The signal light sent to the terminator 30A is optically terminated (blocked) by the terminator 30A (Step S33). Steps S32 and S33 may be carried out in a reversed order or may be carried out simultaneously.

In this way, the monitoring unit 10A according to this implementation carries out rate identification in order on a plurality of signal light having different wavelengths included in the WDM signal light. When at least one of the signal light components having different wavelengths included in the WDM signal light is determined to be input incorrectly, the WDM signal light is blocked by the terminator 30A.

This ensures the same advantage as the first implementation and can lead to a reduction of the size of the optical transmitter 100A.

Moreover, the manufacturing cost of the optical transmitter 100A can be reduced.

In the signal identification procedure according to this implementation, since the wavelength band to be identified is selected by the wavelength-tunable optical filter 3A, the rate can be identified regardless of the number of different wavelengths included in the WDM signal light.

In this implementation, the optical transmitter 100A is set such that the optical gain of each wave is constant and the total power increases as the number of different wavelengths to be wavelength-multiplexed increases. With such an optical transmitter 100A, since the optical gain (i.e., optical power) per wave is constant, a VOA is not required.

### (2.4) Third Implementation

In the implementations described above, the sender (optical transmitter 100 or 100A) identifies the rate of input signal light. When the rate of the input signal light is identified to be an unexpected rate as a result of the rate identification, the sender terminates the input signal light.

In this implementation, the receiver of WDM signal light identifies the rate of wavelength-separated input signal light and transmits (routes) each signal light to routes in response to the identified rate.

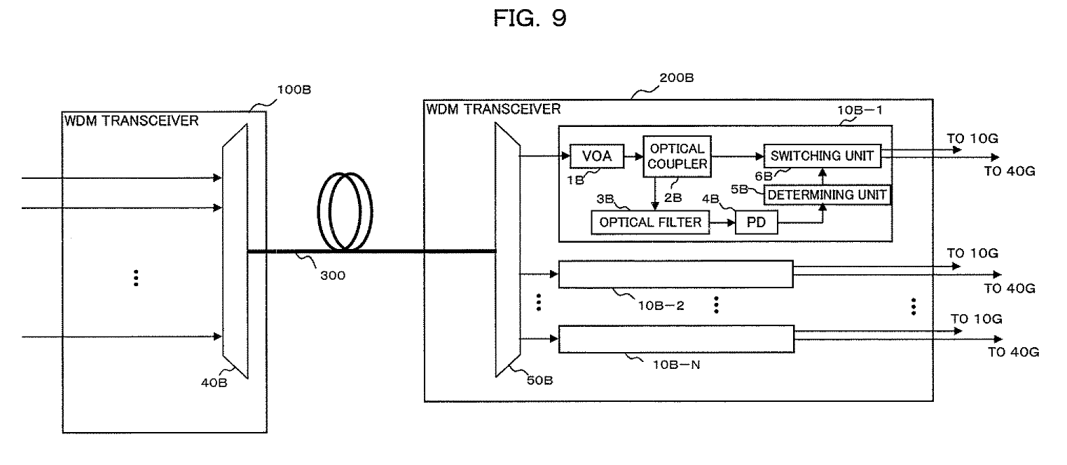

FIG. 9 is a block diagram of a WDM transceiver system according to this implementation. The WDM transceiver system illustrated in FIG. 9 includes a WDM transceiver 100B functioning as an optical transmitter (hereinafter, referred to as optical transmitter 100B), a WDM transceiver 200B functioning as an optical receiver (hereinafter referred to as optical receiver 200B), and an optical transmission line 300 connecting the optical transmitter 100B and the optical receiver 200B.

The optical transmitter 100B includes a WDM coupler 40B. The WDM coupler 40B wavelength-multiplexes a plurality of signal light components having different wavelengths input from networks and sends the wavelength-multiplexed signal light to the optical transmission line 300.

The optical receiver 200B includes a WDM coupler 50B and monitoring units 10B-1 to 10B-N. Hereinafter, the monitoring units 10B-1 to 10B-N will be referred to as monitoring units 10B unless they can be differentiated.

The monitoring units 10B receive the signal light for each wavelength wavelength-multiplexed at the WDM coupler 50B and directly identifies the rate of the signal light.

The signal light of which the rates are identified by the monitoring units 10B is output to a route to a network corresponding to the identified rate.

Therefore, each of the monitoring units 10B includes a VOA 1B, an optical coupler 2B, an optical filter 3B, a PD 4B, a determining unit 5B, and a switching unit 6B.

The VOA 1B regulates signal light for each wavelength input to the monitoring unit 10B from the WDM coupler 50B to a predetermined level of power.

The optical coupler 2B demultiplexes the signal light from the VOA 1B into signal (light) components and test (light) components. The signal components are sent to the switching unit 6B, whereas the test components are sent to the optical filter 3B. The demultiplexing ratio of the signal components to the test components may be approximately 10 to 1.

The optical filter 3B partially removes spectral components of the test components input from the optical coupler 2B. The partially removed spectral components may be, for example, spectral components in a predetermined range not including the central frequency of the test components (i.e., the central frequency of the input signal light) or spectral components in a predetermined range including the central frequency of the test components.

The PD 4B detects the power of the signal light passing the optical filter 3B and notifies the determining unit 5B about the detected result.

The determining unit 5B identifies the rate of the signal light on the basis of the signal light detected at the PD 4B. To identify the rate, for example, the power detected at the PD 4B is compared with a predetermined threshold. The rate is identified on the basis of the result of the comparison. The same rate identification procedures as that described above is employed.

The determining unit 5B controls the operation of the switching unit 6B on the basis of the identified result.

Under the control by the determining unit 5B, the switching unit 6B outputs the signal components from the optical coupler 2B to a route (path) in response to the identified result.

For example, when the determining unit 5B identifies the rate of the input signal light to be 10 Gbps, the input signal light is sent to a route to the 10-G network. When the determining unit 5B identifies the rate of the input signal light to be 40 Gbps, the input signal light is sent to a route to the 40-G network.

Since the optical receiver 200B according to this implementation can directly identify the rate of signal light, a WOM transceiver system that can be easily managed and controlled without complicated routing control can be provided.

Since the signal light wavelength-separated at the WDM coupler 50B has a predetermined wavelength, the optical filter 3B used in the invention may be a relatively inexpensive fixed-wavelength filter.

Furthermore, this implementation enables network monitoring by, for example, notifying the user about information related to the switching setting of each switching unit 6B.

### (2.5) Fourth Implementation

In the third implementation, two different rates (10 Gbps and 40 Gbps) of signal light are identified and the routing is carried out on the basis of the identified rate. Instead, three or more different rates of signal light may be identified to carry out routing.

As mentioned above, the spectral width of the signal light primarily depends on the rate of the signal light (signal light rate), although it also depends on the modulation method. In the case of input of a plurality of signal light components, a sufficiently large difference in the spectral widths will be observed if the rates of the signal light are significantly different. Therefore, a determining unit 5C can detect the difference in power of the signal light passing through an optical filter 3C. As a result, three or more different rates of signal light can be identified.

FIG. 10 is a block diagram of a WDM transceiver system according to a fourth implementation. The WDM transceiver system illustrated in FIG. 10 includes a WDM transceiver 100C functioning as an optical transmitter (hereinafter, referred to as optical transmitter 100C), a WDM transceiver 200C functioning as an optical receiver (hereinafter referred to as optical receiver 200C), and an optical transmission line 300 connecting the optical transmitter 100C and the optical receiver 200C.

The optical transmitter 100C, a WDM coupler 40C, a WDM coupler 50C, a VOA 1C, an optical coupler 2C, an optical filter 3C, and a PD 4C, all illustrated in FIG. 10, respectively have the same functions as the optical transmitter 100B, the WDM coupler 40B, the WDM coupler 50B, the VOA 1B, the optical coupler 2B, the optical filter 3B, and the PD 4B, all illustrated in FIG. 9.

A determining unit 5C for the monitoring units 10C-1 to 10C-N compares the power detected at the PD 4C with a plurality of thresholds. For example, if the three candidate rates of signal light are 10 Gbps, 40 Gbps, and 100 Gbps, the power detected at the PD 4C will be the largest for 10 Gbps and the smallest for 100 Gbps.

Consequently, when the determining unit 5C determines that a power (P) detected at the PD 4C is smaller than a first threshold (x), the rate of input signal light is determined to be 100 Gbps. When the power (P) detected at the PD 4C is determined to be larger than or equal to the first threshold (x) and smaller than a second threshold (y), the rate of input signal light is determined to be 40 Gbps. When the power (P) detected at the PD 4 is determined to be larger than or equal to the second threshold (y), the rate of input signal light is determined to be 10 Gbps. The first threshold (x) and the second threshold (y) are larger than or equal to zero, and the first threshold (x) is smaller than the second threshold (y).

When the number of different rates of the input signal light is m or larger (where m is an integer of two or more), routing control that is the same as that described above can be carried out by appropriately setting m-1 thresholds.

A switching unit 6C for the monitoring units 10C-1 to 10C-N transmits input signal light to routes corresponding to the result identified by the determining unit 5C. In this implementation, since switching to three or more routes is carried out, for example, high-performance optical switches employing micro-electro-mechanical system (MEMS) technology may be used as the switching units 6C.

In this way, the same advantages as those in the implementations described above can be achieved even in the case of the three or more rates of input signal light.

### [3] Others

The configurations and processing of the optical transmitters 100, 100A, 100B, and 100C and the optical receiver 200, 200A, 200B, and 200C may be selected or combined as desired.

In the implementations described above, the rate of signal light is identified on the basis of the difference in power detected at the PD 4 (4A, 4B, or 4C). However, when the rate of signal light is constant, the modulation method of the input signal light may be identified in a similar manner. For example, when the determining unit 5 determines that the power detected at the PD 4 is greater than or equal to a predetermined threshold, the modulation performed on the input signal light is identified as the NRZ modulation. When the determining unit 5 determines that the power detected at the PD 4 is smaller than a predetermined threshold, the modulation performed on the input signal light is identified as the DPSK modulation (or DQPSK modulation).

The WDM transceiver systems illustrated in FIGS. 2, 9, and 10 use the VOAs 1, 1B, and 1C, respectively. Alternatively, amplifiers or equalizers that can regulate the power of input signal light to a predetermined power may be used.

In the implementations described above, WDM transceiver systems are described. The implementations may also be applied in any other transceiver system.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments) has (have) been described in detail, it should be understood that the various changes, substitutions, and alterations could be made hereto without departing from the spirit and scope of the invention.

1. A signal light identifying apparatus comprising:
an optical filter partially removing spectral components of input signal light regulated to have predetermined power; and
an identifying unit identifying a rate of the input signal light in response to power of signal light passing through the optical filter.

2. The signal light identifying apparatus according to claim 1, further comprising:
an optical switch unit configured to output the signal light to a route corresponding to a result of the identification by the identifying unit.

3. The signal light identifying apparatus according to claim 2, wherein the route comprises a route directed to an optical terminating unit terminating the signal light.

4. The signal light identifying apparatus according to claim 2, wherein the route comprises a route directed to a network corresponding to the rate identified by the identifying unit.

5. The signal light identifying apparatus according to claim 1, further comprising:
an alarm processing unit configured to carry out alarm processing upon identifying the rate is not an expected rate of the input signal light.

6. The signal light identifying apparatus according to claim 1, wherein the partially removed spectral components comprises spectral components excluding spectral components in a predetermined range, the predetermined range including the central frequency of the input signal light.

7. The signal light identifying apparatus according to claim 1, wherein the partially removed spectral components comprises spectral components that includes spectral components in a predetermined including the central frequency of the input signal light.

8. The signal light identifying apparatus according to claim 6, wherein the optical filter comprises a wavelength-tunable filter capable of changing the predetermined range.

9. The signal light identifying apparatus according to claim 7, wherein the optical filter comprises a wavelength-tunable filter capable of changing the predetermined range.

10. A wavelength division multiplexing (WDM) transceiver transmitting WDM signal light, comprising:
a wavelength multiplexing unit wavelength-multiplexing a plurality of signal light components having different wavelengths; and
the signal light identifying apparatus according to claim 1 identifying rates of input signal light, the input signal light being each of the plurality of signal light components or being the WDM signal light wavelength-multiplexed by the wavelength multiplexing unit.

11. A method of identifying signal light, comprising:
partially removing spectral components of an input signal light having regulated predetermined by passing the input signal light through an optical filter; and
identifying a rate of the input signal light in response to the power of signal light passing through the optical filter.
